(19) United States
(12) Patent Application Publication
(10) Pub. No.: US 2026/0319980 A1
(43) Pub. Date: Oct. 15, 2026

(54) MEMORY MANAGEMENT AND TASK SCHEDULING IN COMPUTING DEVICES AND COMPUTING SYSTEMS

(71) Applicants: SAMSUNG ELECTRONICS CO., LTD., Suwon-si (KR); RESEARCH & BUSINESS FOUNDATION SUNGKYUNKWAN UNIVERSITY, Suwon-si (KR)

(72) Inventors: Sukmin KANG, Suwon-si (KR); Jinkyu LEE, Suwon-si (KR); Seongtae LEE, Suwon-si (KR)

(73) Assignees: SAMSUNG ELECTRONICS CO., LTD., Suwon-si (KR); RESEARCH & BUSINESS FOUNDATION SUNGKYUNKWAN UNIVERSITY, Suwon-si (KR)

(21) Appl. No.: 19/368,750

(22) Filed: Oct. 24, 2025

(30) Foreign Application Priority Data
Apr. 15, 2025 (KR) 10-2025-0049125

(51) Int. Cl. G06F 13/28

(52) U.S. Cl. CPC G06F 13/28

(57) ABSTRACT

A computing device includes a memory device, a direct memory access (DMA) controller that is configured to load a first task into the memory device on a segment-by-segment basis, the first task being associated with a deep neural network (DNN) model and including a plurality of segments, and wherein the plurality of segments include a first segment and a second segment; and a processor configured to execute at least one segment loaded in the memory device on a segment-by-segment basis, wherein each of the plurality of segments is included in one of a plurality of segment groups, the plurality of segment groups including a first segment group and a second segment group.

### CROSS-REFERENCE TO RELATED APPLICATION

This application claims priority to Korean Patent Application No. 10-2025-0049125, filed in the Korean Intellectual Property Office on Apr. 15, 2025, the entire contents of which are hereby incorporated by reference.

### BACKGROUND

The present disclosure relates to a computing device and a computing system including the same, and more specifically, to a computing device that performs tasks associated with one or more deep neural network (DNN) models.

Recently, artificial intelligence-based deep neural network (DNN) models have been widely used in various fields where real-time data processing is required, such as IoT devices, wearable devices, and autonomous vehicles. Because such devices have limited memory capacity and computing resources, a bottleneck phenomenon may easily occur in the process of processing large-capacity data. In particular, if the structure of the deep neural network model is complex and the amount of computation is large, the efficiency of the operation for processing data may be significantly reduced.

Meanwhile, in the conventional computing device, a single processor (e.g., CPU) is in charge of both the loading and execution processes of data required for the execution of the deep neural network model, or the processor is configured to simply sequentially process the loading and execution processes of data without separate control in many cases. In this case, the load on the processor is increased, and the delay in the data processing process is accumulated, which may limit securing real-time performance of the operation. Accordingly, there is an increasing demand for a technology that can stably perform a task associated with a deep neural network model while efficiently utilizing limited resources.

The above information is provided to enhance the understanding of the background of the present disclosure and may include information that does not constitute the related art.

### SUMMARY

The present disclosure relates to a computing device and a computing system including the same to solve the above problems.

The problem to be solved by the present disclosure is not limited to the above, and other problems not mentioned may be clearly understood by those skilled in the art from the description of the present disclosure below.

In some embodiments, a computing device may include a memory device, a direct memory access (DMA) controller that is configured to load a first task into the memory device on a segment-by-segment basis, the first task being associated with a deep neural network (DNN) model and including a plurality of segments, and wherein the plurality of segments include a first segment and a second segment; and a processor configured to execute at least one segment loaded in the memory device on a segment-by-segment basis, wherein each of the plurality of segments is included in one of a plurality of segment groups, the plurality of segment groups including a first segment group and a second segment group, wherein the memory device includes a first memory area and a second memory area, and the first memory area and the second memory area are separately allocated in the memory device, wherein the DMA controller is further configured to, during a time that data associated with the first segment included in the first segment group is maintained in the first memory area, load data associated with the second segment included in the second segment group into the second memory area, and wherein the processor is further configured to access the first memory area during a same time the DMA controller accesses the second memory area.

In some embodiments, a computing system may include an external device storing tasks associated with a deep neural network model, and a computing device connected to the external device to execute the tasks, wherein the computing device may include a memory device, a direct memory access (DMA) controller that is configured to load a first task into the memory device on a segment-by-segment basis, the first task being associated with a deep neural network (DNN) model and including a plurality of segments, and wherein the plurality of segments include a first segment and a second segment; and a processor configured to execute at least one segment loaded in the memory device on a segment-by-segment basis, wherein each of the plurality of segments is included in one of a plurality of segment groups, the plurality of segment groups including a first segment group and a second segment group, wherein the memory device includes a first memory area and a second memory area, and the first memory area and the second memory area are separately allocated in the memory device, wherein the DMA controller is further configured to, during a time that data associated with the first segment included in the first segment group is maintained in the first memory area, load data associated with the second segment included in the second segment group into the second memory area, and wherein the processor is further configured to access the first memory area during a same time the DMA controller accesses the second memory area.

In some embodiments, a computing device may include a memory device, a direct memory access (DMA) controller configured to load a first task into the memory device on a segment-by-segment basis, the first task being associated with a deep neural network (DNN) model and including a plurality of segments, and wherein the first task and a second task are associated with a deep neural network model; and a processor configured to execute at least one segment loaded in the memory device on a segment-by-segment basis, wherein the DMA controller is further configured to load the second task subsequent to the first task based on execution of the first task being completed, wherein each of the plurality of segments included in the first task is included in one of a plurality of segment groups, the plurality of segment groups including a first segment group and a second segment group, wherein the memory device includes a first memory area and a second memory area, and the first memory area and the second memory area are separately allocated in the memory device, wherein the DMA controller is further configured to, during a time that data associated with the first segment included in the first segment group is maintained in the first memory area, load data associated with the second segment included in the second segment group into the second memory area, and wherein the processor is further configured to access the first memory area during a same time the DMA controller accesses the second memory area.

The effects obtainable through the present disclosure are not limited to those mentioned above. Additional technical effects will be clearly understood by those skilled in the art from the description of the present disclosure described below.

### BRIEF DESCRIPTION OF DRAWINGS

FIG. 1 is a block diagram schematically illustrating a structure of a computing system according to an embodiment of the present disclosure.

FIG. 2 is a diagram for illustrating a process of performing a task by a computing device according to an embodiment of the present disclosure.

FIG. 3 is a diagram illustrating dividing a task into a plurality of segments.

FIG. 4 is a diagram illustrating a process for allocating each of a plurality of segments to any one of a plurality of segment groups according to an embodiment of the present disclosure.

FIGS. 5 to 7 are diagrams illustrating task performance according to some embodiments of the present disclosure.

FIGS. 8 and 9 are diagrams illustrate a memory area being allocated in a memory device according to some embodiments of the present disclosure.

FIG. 10 is a diagram illustrating allocating each of a plurality of segments included in a task to any one of a plurality of segment groups according to an embodiment of the present disclosure.

FIG. 11 is a diagram illustrating performing a plurality of tasks according to an embodiment of the present disclosure.

FIG. 12 is a diagram illustrating a process of performing a plurality of tasks by a computing device according to an embodiment of the present disclosure.

FIGS. 13 and 14 are diagrams illustrating executing a plurality of tasks in a computing device according to conventional techniques.

### DETAILED DESCRIPTION

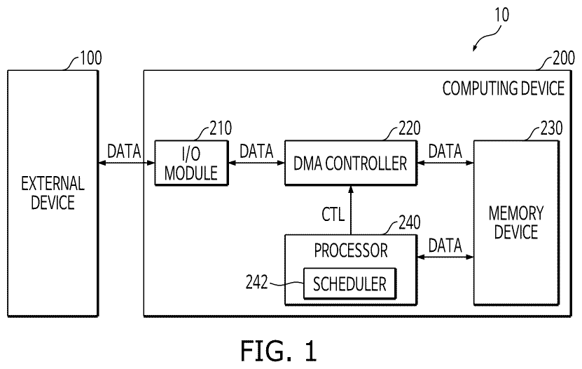

Hereinafter, various embodiments of the present disclosure will be described with reference to FIGS. 1 to 14. Throughout the specification, the same reference numerals may refer to the same components.

In the present disclosure, ‘each of a plurality of A’ may refer to each of all components included in the plurality of A, or may refer to each of some components included in the plurality of A.

In the present disclosure, ‘storing or loading data in a memory area’ may mean storing or loading data in at least a portion of the memory area. For example, storing data associated with the third segment in the first memory area may mean storing data associated with the third segment in a portion or all of the first memory area.

According to various embodiments of the present disclosure, the computing device may include a DMA controller. The loading and execution of the plurality of segments included in the task are performed in parallel by the DMA controller and the processor, thereby reducing the time required to perform the task and reducing the load on the processor.

According to various embodiments of the present disclosure, the loading and execution of each of the segments are sequentially performed for the segments included in the same segment group, and the loading and execution of each of the segments are performed in parallel for the segments included in different segment groups. The processor and the DMA controller are executed asynchronously, thereby maximizing parallel processing efficiency for the task within a limited memory environment, and reducing the task execution time.

According to various embodiments of the present disclosure, information on the plurality of segments for dividing the task and information for allocating each of the plurality of segments to any one of the plurality of segment groups are determined in advance before the task is performed, thereby reducing the load on the processor in the process of performing the task.

According to various embodiments of the present disclosure, the computing device may limit the resources of the DMA controller and the processor from being preempted by another task until the loading and execution of all segments included in one task are completed. Accordingly, when the computing device performs a plurality of tasks, interference between the plurality of tasks is minimized, and the worst-case execution time (WCET) of each task may be predicted more accurately.

FIG. 1 is a block diagram schematically illustrating a structure of a computing system 10 according to an embodiment of the present disclosure. As illustrated, the computing system 10 may include an external device 100 and a computing device 200.

The external device 100 may include a storage medium in which information on one or more deep neural network (DNN) models is stored. For example, the external device 100 may include a mass storage medium such as an SD card, an external flash memory, and an external System on Chip (SoC) having a high-speed communication interface, but is not limited thereto.

The computing device 200 may be connected to the external device 100 to transmit and receive data. For example, the computing device 200 may receive a task associated with the deep neural network model from the external device 100, and be configured to execute the received task. In an embodiment, the computing device 200 may include an input/output module 210, a direct memory access (DMA) controller 220, a memory device 230, and a processor 240, but is not limited thereto, and additional configurations may be further included in the computing device 200, or some configurations may be omitted from the computing device 200.

The input/output module 210 may function as a communication interface for data transmission and reception with the external device 100. For example, the input/output module 210 may receive data from the external device 100 or transmit data to the external device 100 through a communication protocol. The input/output module 210 may include at least one of standard communication interfaces such as a serial peripheral interface (SPI), a universal asynchronous receiver transmitter (UART), and an inter-integrated circuit (I2C), but is not limited thereto.

The input/output module 210 may receive a task associated with the deep neural network model from the external device 100, and transmit the received task to the DMA controller 220. Here, the received task may include information on one or more segments included in the task and a segment group to which each of the one or more segments belongs. The DMA controller 220 may control the transmission of data without the intervention of the processor 240 (e.g., CPU). For example, the DMA controller 220 may acquire control of the system bus from the processor 240 to directly manage data transmission between the memory device 230 and the DMA controller 220 and/or data transmission between the memory device 230 and a separate peripheral device (e.g., the input/output module 210).

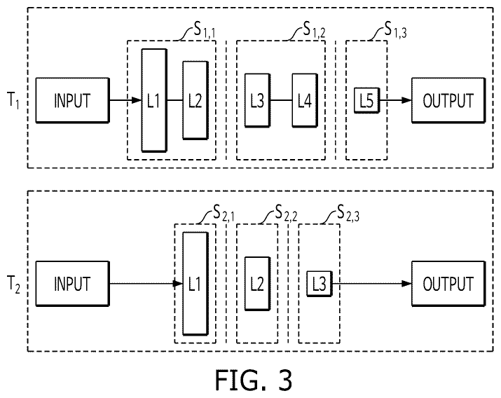

In an embodiment, the task transmitted from the external device 100 may include a plurality of segments. Here, the segment may refer to a division unit of a task for performing a task associated with the deep neural network model. Each of the plurality of segments may include information on at least one layer of the plurality of layers of the deep neural network model. An example in which the task is divided into a plurality of segments will be described in more detail later with reference to FIG. 3.

The memory device 230 may store the plurality of segments loaded by the DMA controller 220. For example, the DMA controller 220 may load the plurality of segments included in the task on a segment-by-segment basis. The memory device 230 may store at least one segment loaded through the DMA controller 220, and maintain data associated with the segment in a specific memory area while or during a time the processor 240 executes the segment. It will be understood that there may be a partial or complete overlap in the time during which memory device 230 maintains data associated with the segment in a specific memory area and the time during which the processor 240 executes the segment. The DMA controller 220 may dynamically control the transmission of each segment according to a control signal (CTL) received from the processor 240. The memory device 230 may include a volatile memory (e.g., SRAM, DRAM, etc.) with a limited capacity, but is not limited thereto.

The processor 240 may function as a central processing unit of the computing device 200. For example, the processor 240 may request the transmission of data required for the execution of the task from the external device 100 by transmitting a control signal (CTL) to the DMA controller 220, or execute the task stored in the memory device 230 on a segment-by-segment basis.

In an embodiment, a scheduler 242 configured to allocate each of the plurality of segments included in the task to any one of the plurality of segment groups may be included in the computing system 10.

For example, the scheduler 242 may be a type of software module driven within the processor 240. The scheduler 242 may determine scheduling information for dividing the task into a plurality of segments and allocating the divided plurality of segments to any one of the plurality of segment groups based on metadata associated with the task (e.g., code information of the deep neural network model). For example, the scheduler 242 may determine scheduling information for the task at some time before the task is started. The metadata associated with the task may be stored in the memory device 230 inside the computing device 200 and/or a non-volatile memory device (not shown) configured separately from the memory device 230 in the computing device 200, but is not limited thereto.

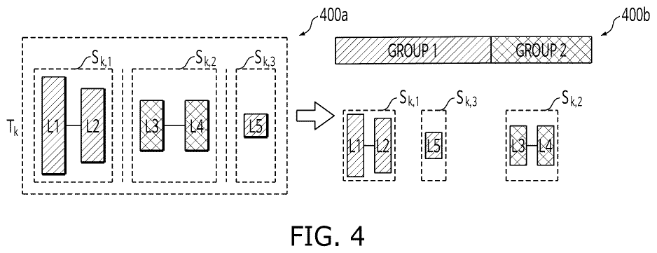

As another example, the scheduler 242 may be disposed outside the computing device 200. In this case, the scheduling information determined by the scheduler 242 may be transmitted from the external device 100 to the processor 240 of the computing device 200. Such scheduling information may be provided together with the computing device 200 when the computing device 200 loads and executes the segment, or at least a portion of such scheduling information may be provided in advance before the computing device 200 loads and executes the segment. An example in which each of the plurality of segments is allocated to any one of the plurality of segment groups will be described in more detail later with reference to FIGS. 4 to 9.

In an embodiment, the processor 240 may execute the plurality of segments included in the task on a segment-by-segment basis based on the scheduling information determined by the scheduler 242. In addition, the processor 240 may transmit a control signal to the DMA controller 220 to load the plurality of segments on a segment-by-segment basis based on the scheduling information determined by the scheduler 242. The processor 240 may transmit a control signal to the DMA controller 220 on a segment-by-segment basis to load a specific segment, but is not limited thereto. For example, the processor 240 may transmit a control signal to load a specific segment in task units or segment group units.

In an embodiment, the computing device 200 may further include a non-volatile memory device (not shown). For example, the non-volatile memory device may be used to store at least one task performed in the computing device 200 together with the external device 100. In this case, the DMA controller may also load the task from the non-volatile memory device on a segment-by-segment basis.

In an embodiment, the computing device 200 may include an embedded device based on a micro-controller unit (MCU). For example, the computing device 200 may be applied to an IoT device, a wearable healthcare device, a control unit of an autonomous vehicle, and the like. In this case, the computing device 200 may have difficulty storing a task associated with the deep neural network model or loading and executing the entire task associated with the deep neural network model at once due to a limited memory environment.

In the present disclosure, a computing device capable of guaranteeing real-time performance of a task while efficiently executing the task associated with the deep neural network model in a limited memory environment will be described.

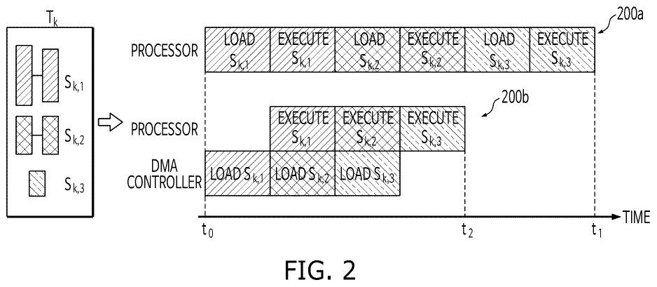

FIG. 2 is a diagram for comparing and describing a process of performing a task by a computing device according to an embodiment of the present disclosure and a process of performing a task by a computing device according to an example. For example, a first example 200a is a diagram for describing a process in which a task is executed by a computing device according to an example, and a second example 200b is a diagram for describing a process in which a task is executed by a computing device according to an embodiment of the present disclosure.

The computing device may perform a task Tₖ associated with the deep neural network model. At this time, the task Tₖ may include a plurality of segments S_{k,1}, S_{k,2}, and S_{k,3}. The computing device may load or execute the plurality of segments S_{k,1}, S_{k,2}, and S_{k,3} included in the task Tₖ on a segment-by-segment basis.

Referring to the first example 200a, the computing device according to the example may not include a DMA controller, or the processor may perform both the loading and execution of the segments. For example, the processor may load each of the plurality of segments S_{k,1}, S_{k,2}, and S_{k,3} included in the task Tₖ and store it in the memory device. In addition, the processor may execute each of the plurality of segments S_{k,1}, S_{k,2}, and S_{k,3} stored in the memory device on a segment-by-segment basis.

As a specific example, the processor may load the first segment S_{k,1} of the plurality of segments S_{k,1}, S_{k,2}, and S_{k,3} of the task Tₖ stored in the external device through the input/output module (e.g., the input/output module 210 in FIG. 1) connected to the external device (e.g., external device 100 in FIG. 1). In response to the completion of the loading of the first segment S_{k,1}, the processor may execute the first segment S_{k,1}. Thereafter, in response to the completion of the execution of the first segment S_{k,1}, the processor may start loading the second segment S_{k,2} subsequent to the first segment S_{k,1}. In addition, in response to the completion of the loading of the second segment S_{k,2}, the processor may execute the second segment S_{k,2}. That is, the processor may sequentially repeat loading and execution for each of the plurality of segments S_{k,1}, S_{k,2}, and S_{k,3} included in the task Tₖ.

Referring to the second example 200b, the computing device according to an embodiment of the present disclosure may include a DMA controller. The DMA controller may load the plurality of segments S_{k,1}, S_{k,2}, and S_{k,3} of the task Tₖ stored in the external device through the input/output module (e.g., the input/output module 210 in FIG. 1) connected to the external device without the intervention of the processor. In this case, the loading of the segment by the DMA controller (e.g., DMA controller 220 in FIG. 1) and the execution of the segment by the processor (e.g., processor 240 in FIG. 1) may be performed in parallel with each other.

For example, the DMA controller may load the first segment S_{k,1} of the plurality of segments S_{k,1}, S_{k,2}, and S_{k,3} included in the task Tₖ through the input/output module connected to the external device. In response to the completion of the loading of the first segment S_{k,1}, the DMA controller may start loading the second segment S_{k,2} subsequent to the first segment S_{k,1}, and the processor may execute the first segment S_{k,1}. Thereafter, in response to the completion of the loading of the second segment S_{k,2} by the DMA controller and the completion of the execution of the first segment S_{k,1} by the processor, the processor may start the execution of the second segment S_{k,2}. Additionally, the DMA controller may start loading the third segment S_{k,3} in response to the completion of the loading of the second segment S_{k,2}. Then, in response to the completion of the execution of the second segment S_{k,2} by the processor and the completion of the loading of the third segment S_{k,3} by the DMA controller, the processor may start the execution of the third segment S_{k,3}.

That is, according to the second example 200b, while or during a time a specific segment is executed by the processor, the loading of the segment subsequent to the specific segment may be performed by the DMA controller. In other words, at least a portion of the time during which a specific segment is executed by the processor and the time during which a segment subsequent to the specific segment is loaded by the DMA controller may overlap.

With such a configuration, the loading and execution of the plurality of segments S_{k,1}, S_{k,2}, and S_{k,3} included in the task Tₖ are performed in parallel by the DMA controller and the processor, thereby reducing the time required to perform the task Tₖ and reducing the load on the processor.

FIG. 3 is a diagram for describing an example in which a task according to an embodiment of the present disclosure is divided into a plurality of segments, and FIG. 4 is a diagram for describing an example in which each of the plurality of segments according to an embodiment of the present disclosure is allocated to any one of a plurality of segment groups.

In an embodiment, the computing device (e.g., computing device 200 in FIG. 1) may perform a task associated with at least one deep neural network model. For example, when the computing device performs a task for a plurality of deep neural network models, a plurality of tasks T₁ and T₂ corresponding to each of the plurality of deep neural network models may be independently performed according to each cycle. Here, the plurality of tasks T₁ and T₂ may refer to tasks corresponding to each of the different plurality of deep neural network models, but are not limited thereto, and each of the plurality of tasks T₁ and T₂ may refer to a task that is executed at different times and corresponds to the same deep neural network model.

Referring to FIG. 3, each of the plurality of tasks T₁ and T₂ may include a plurality of segments. Here, each of the plurality of segments may include information on at least one layer of the plurality of layers of the deep neural network model.

For example, the deep neural network model corresponding to the first task T₁ may be composed of a plurality of layers L1 to L5. Each of the plurality of segments S_{1,1}, S_{1,2}, and S_{1,3} included in the task T₁ may be determined to include information on at least one layer of the plurality of layers L1 to L5. In addition, each of the plurality of segments S_{1,1}, S_{1,2}, and S_{1,3} may include any data (e.g., data such as parameters, operator information, bias, weights, etc.) required for the operation of at least one layer corresponding to each of the plurality of segments S_{1,1}, S_{1,2}, and S_{1,3}.

In FIG. 3, it is illustrated that each of the first task T₁ and the second task T₂ includes three segments, but the number of segments included in the task T₁ and T₂ is not limited thereto. In addition, the size (or capacity) of each segment may be determined differently. In order to optimize the execution process of the task T₁ and T₂, the number and size of segments included in the task T₁ and T₂ may be determined in advance by the scheduler before the task T₁ and T₂ are executed. Additionally, before the task T₁ and T₂ are executed, each of the plurality of segments included in the task may be allocated to any one of the plurality of segment groups. An example in which each of the plurality of segments is allocated to any one of the plurality of segment groups will be described later in detail with reference to FIG. 4.

Referring to FIG. 4, the plurality of segments S_{k,1}, S_{k,2}, and S_{k,3} included in the task Tₖ may be allocated to one of the plurality of segment groups. The scheduler is a type of software module driven on the processor, and first information 400a on the plurality of segments S_{k,1}, S_{k,2}, and S_{k,3} for dividing the task Tₖ (hereinafter, referred to as ‘first information’), and second information 400b for allocating each of the plurality of segments S_{k,1}, S_{k,2}, and S_{k,3} to any one of the plurality of segment groups (hereinafter, referred to as ‘second information’) may be determined.

In an embodiment, the first information 400a and the second information 400b associated with the task Tₖ may be determined before the task Tₖ is performed. Thereafter, the computing device may perform the task Tₖ based on the determined first information 400a and second information 400b.

In an embodiment, an area in which the plurality of segments S_{k,1}, S_{k,2}, and S_{k,3} included in the task Tₖ are stored in the memory device may be determined based on the first information 400a and the second information 400b associated with the task Tₖ. For example, segments allocated to different segment groups among the plurality of segments S_{k,1}, S_{k,2}, and S_{k,3} included in the task Tₖ may be stored in different memory areas in the memory device. For example, the first segment S_{k,1} included in the first segment group Group 1 may be stored in the first memory area of the memory device, and the second segment S_{k,2} included in the second segment group Group 2 may be stored in the second memory area of the memory device. The second memory area may refer to an area separately allocated from the first memory area in the memory device.

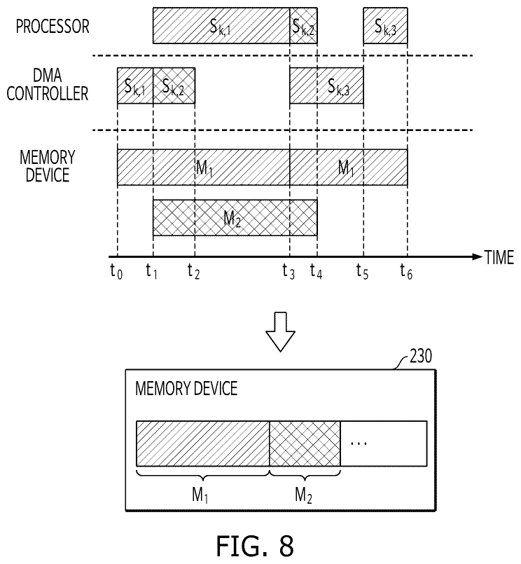

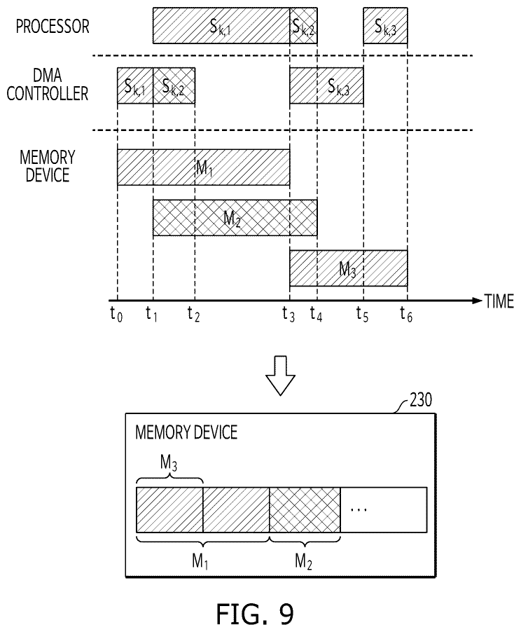

In an embodiment, segments allocated to one segment group among the plurality of segments S_{k,1}, S_{k,2}, and S_{k,3} included in the task Tₖ may be stored in the same memory area in the memory device. For example, the first segment S_{k,1} and the third segment S_{k,3} included in the first segment group may both be stored in the first memory area of the memory device. However, the present disclosure is not limited thereto, and the third segment S_{k,3} may be stored in the third memory area partially overlapping the first memory area. A specific example thereof will be described in more detail later with reference to FIGS. 8 and 9.

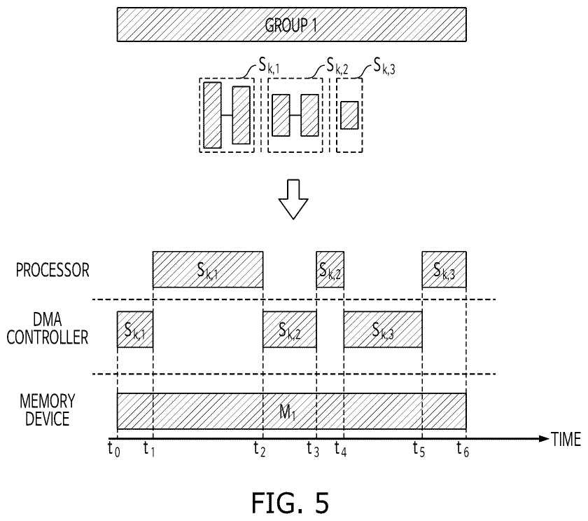

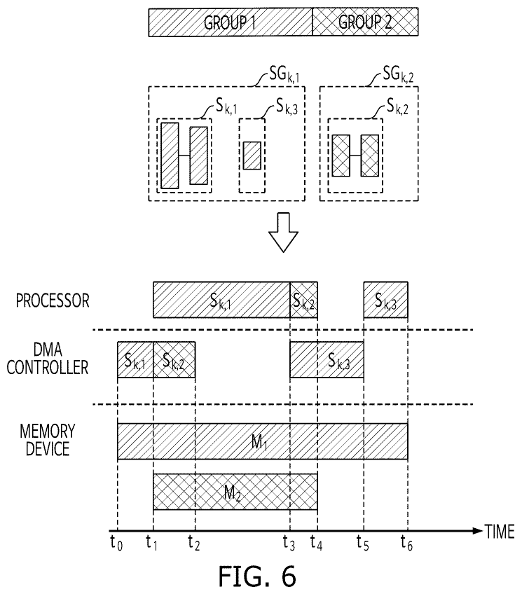

In an embodiment, the order in which the plurality of segments S_{k,1}, S_{k,2}, and S_{k,3} included in the task Tₖ are loaded and executed may be determined based on the first information 400a and the second information 400b associated with the task Tₖ. For example, the computing device may sequentially perform loading and execution of segments for segments included in one segment group, that is, segments stored in one memory area. As a specific example, when the first segment S_{k,1} included in the first segment group and the third segment S_{k,1} subsequent to the first segment S_{k,1} are performed, the processor may start the execution of the first segment S_{k,1} in response to the completion of the loading of the first segment S_{k,1} by the DMA controller. In addition, the DMA controller may start loading the third segment S_{k,1} in response to the completion of the execution of the first segment S_{k,1}. An example in which segments included in one segment group are loaded and executed will be described in more detail later with reference to FIGS. 5 and 6.

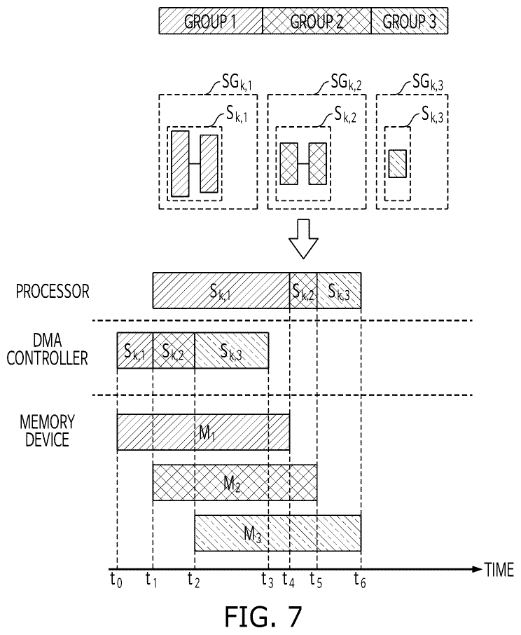

In an embodiment, the computing device may perform loading and execution of each of the segments in parallel for segments included in different segment groups, that is, segments stored in different memory areas. As a specific example, while the processor executes the first segment S_{k,1} included in the first segment group, the DMA controller may load the second segment S_{k,2} included in the second segment group with the time overlap in time being partial or complete. In addition, while the processor executes the second segment S_{k,2} included in the second segment group, the DMA controller may load the third segment S_{k,3} included in the first segment group. In embodiments, the time overlap in time may be partial or complete. An example in which segments included in different segment groups are loaded and executed will be described in more detail later with reference to FIGS. 6 and 7.

In an embodiment, the scheduler may determine the first information 400a and the second information 400b for the task Tₖ based on the deadline of the task Tₖ. For example, the first information 400a and the second information 400b for the task Tₖ may be determined such that the execution completion time of the task Tₖ is within the predetermined deadline of the task Tₖ.

Additionally or alternatively, the scheduler may determine the first information 400a and the second information 400b for the task Tₖ based on the capacity of the memory device (e.g., memory device 230 in FIG. 1). For example, the first information 400a and the second information 400b for the task Tₖ may be determined such that the sum of the capacities of the memory areas simultaneously accessed by the DMA controller and the processor at any time during the execution of the task Tₖ is within the total capacity of the memory device.

For example, the scheduler may generate at least one layer-segment correspondence combination such that each of the plurality of layers L1 to L5 constituting the task Tₖ is included in at least one segment. In addition, the scheduler may generate at least one segment-segment group correspondence combination such that at least one segment determined based on the at least one layer-segment correspondence combination is allocated to at least one segment group. Thereafter, the execution process of the task Tₖ may be simulated for the generated layer-segment correspondence combinations and segment-segment group correspondence combinations. Accordingly, the scheduler may select at least one segment-segment group correspondence combination such that the execution completion time of the task Tₖ is within the predetermined deadline of the task Tₖ and the sum of the capacities of the memory areas simultaneously accessed by the DMA controller and the processor at any time during the execution of the task Tₖ is within the total capacity of the memory device. The scheduler may finally determine the first information 400a and the second information 400b for the task Tₖ based on the selected segment-segment group correspondence combination, and the computing device may perform the task Tₖ based on the determined first information 400a and second information 400b.

In an embodiment, the first information 400a and the second information 400b for the task Tₖ may be determined such that the execution completion time of the task Tₖ is within the predetermined deadline of the task Tₖ and the task execution time is minimized, but is not limited thereto. In addition, the first information 400a and the second information 400b for the task Tₖ may be determined such that the sum of the capacities of the memory areas simultaneously accessed by the DMA controller and the processor at any time during the execution of the task Tₖ is within the total capacity of the memory device, and the sum of the capacities of the memory areas simultaneously accessed by the DMA controller and the processor is minimized, but is not limited thereto.

With such a configuration, the loading and execution of each of the segments are sequentially performed for the segments included in the same segment group, and the loading and execution of each of the segments are performed in parallel for the segments included in different segment groups. Accordingly, the processor and the DMA controller are executed asynchronously, thereby maximizing parallel processing efficiency for the task within a limited memory environment.

In addition, information on the plurality of segments S_{k,1}, S_{k,2}, and S_{k,3} for dividing the task Tₖ and information for allocating the plurality of segments S_{k,1}, S_{k,2}, and S_{k,3} to one of the plurality of segment groups are determined in advance before the task Tₖ is performed, thereby reducing the load on the processor of the computing device in the process of performing the task Tₖ.

FIGS. 5 to 7 are diagrams for describing an example in which a task according to some embodiments of the present disclosure is performed. FIGS. 5 to 7 are diagrams for describing an example in which when a task including a plurality of segments S_{k,1}, S_{k,2}, and S_{k,3} is performed, the time required to perform the task is determined differently depending on the number of segment groups to which the plurality of segments S_{k,1}, S_{k,2}, and S_{k,3} are allocated.

Referring to FIG. 5, the plurality of segments S_{k,1}, S_{k,2}, and S_{k,3} included in the task may all be allocated to one segment group (hereinafter, the first segment group). In this case, the computing device (e.g., computing device 200 in FIG. 1) may sequentially perform loading and execution for each of the plurality of segments S_{k,1}, S_{k,2}, and S_{k,3} included in the first segment group.

For example, the DMA controller (e.g., DMA controller 220 in FIG. 1) may load the first segment S_{k,1} into the first memory area M1 of the memory device (e.g., memory device 230 in FIG. 1) in response to receiving a control signal to perform the task from the processor (e.g., processor 240 in FIG. 1). In response to the completion of the loading of the first segment S_{k,1}, the processor may start the execution of the first segment S_{k,1}. In addition, the memory device may maintain data associated with the first segment S_{k,1} (e.g., operator information, intermediate calculation value information, etc.) in the first memory area M1 while the first segment S_{k,1} is executed.

Thereafter, in response to the completion of the execution of the first segment S_{k,1}, the DMA controller may start loading the second segment S_{k,2} subsequent to the first segment S_{k,1} into the first memory area M1. In addition, in response to the completion of the loading of the second segment S_{k,2}, the processor may start the execution of the second segment S_{k,2}, and the memory device may maintain data associated with the first segment S_{k,1} in the first memory area M1 while the second segment S_{k,2} is executed. The loading and execution of the third segment S_{k,3} may also be performed in the same or similar manner as described above.

Referring to FIG. 6, the plurality of segments S_{k,1}, S_{k,2}, and S_{k,3} included in the task may be allocated to two different segment groups. For example, the first segment S_{k,1} and the third segment S_{k,3} may be allocated to the first segment group SG_{k,1}, and the second segment S_{k,2} may be allocated to the second segment group SG_{k,2}. In addition, the task of FIG. 6 may be the same task as the task of FIG. 5.

In an embodiment, the computing device may sequentially perform loading and execution for segments included in the same segment group, and may perform loading and execution in parallel for segments included in different segment groups.

For example, the DMA controller may load the first segment S_{k,1} included in the first segment group SG_{k,1} into the first memory area M1 of the memory device in response to receiving a control signal to execute the task from the processor. In response to the completion of the loading of the first segment S_{k,1}, the processor may start the execution of the first segment S_{k,1}. In addition, the memory device may maintain data associated with the first segment S_{k,1} in the first memory area M1 while the first segment S_{k,1} is executed. Additionally, in response to the completion of the loading of the first segment S_{k,1}, the DMA controller may start loading the second segment S_{k,2} included in the second segment group SG_{k,2} into the second memory area M2. Here, the second memory area M2 may be an area separately allocated from the first memory area M1 within the memory device. In this case, access to the first memory area by the processor and access to the second memory area by the DMA controller may be performed simultaneously for at least a portion of time (e.g., time from t₁ to t₂).

Thereafter, in response to the completion of the loading of the second segment S_{k,2} by the DMA controller and the completion of the execution of the first segment S_{k,1} by the processor, the processor may start the execution of the second segment S_{k,2}, and the DMA controller may load the third segment S_{k,3} included in the first segment group SG_{k,1} into the first memory area M1 of the memory device. In this case, access to the second memory area by the processor and access to the first memory area by the DMA controller may be performed simultaneously for at least a portion of time (e.g., time from t₃ to t₄).

Thereafter, in response to the completion of the loading of the third segment S_{k,3} by the DMA controller and the completion of the execution of the second segment S_{k,2} by the processor, the processor may start the execution of the third segment S_{k,3}.

With such a configuration, the DMA controller and the processor perform loading and execution in parallel for segments included in different segment groups, thereby reducing the time required to perform the task. For example, according to the example of FIG. 6, access to different memory areas is performed simultaneously by the processor and the DMA controller for at least a portion of time (e.g., time from t₁ to t₂, time from t₃ to t₄), thereby reducing the time required to perform the task by that amount of time (e.g., time from t₁ to t₂, time from t₃ to t₄) compared to the example of FIG. 5. When access to different memory areas is performed simultaneously by the processor and the DMA controller, the sum of the capacities of the memory areas may be determined to be less than or equal to the total capacity of the memory device.

Referring to FIG. 7, the plurality of segments S_{k,1}, S_{k,2}, and S_{k,3} included in the task may be allocated to three different segment groups. For example, the first segment S_{k,1} may be allocated to the first segment group SG_{k,1}, the second segment S_{k,2} may be allocated to the second segment group SG_{k,2}, and the third segment S_{k,3} may be allocated to the third segment group SG_{k,3}. In addition, the task of FIG. 7 may be the same task as the tasks of FIGS. 5 and 6. In FIG. 7, descriptions of configurations explained in or overlapping with FIG. 6 are omitted.

In an embodiment, the DMA controller may load the first segment S_{k,1} included in the first segment group SG_{k,1} into the first memory area M1 of the memory device in response to receiving a control signal to execute the task from the processor. In response to the completion of the loading of the first segment S_{k,1}, the processor may start the execution of the first segment S_{k,1}. The memory device may maintain data associated with the first segment S_{k,1} in the first memory area M1 while the first segment S_{k,1} is executed. In response to the completion of the loading of the first segment S_{k,1}, the DMA controller may start loading the second segment S_{k,2} included in the second segment group SG_{k,2} into the second memory area M2. In this case, access to the first memory area by the processor and access to the second memory area by the DMA controller may be performed simultaneously for at least a portion of time (e.g., time from t₁ to t₂).

Additionally, in response to the completion of the loading of the second segment S_{k,2}, the DMA controller may start loading the third segment S_{k,3} included in the third segment group SG_{k,3} into the third memory area M3. That is, the DMA controller may start loading the third segment S_{k,3} into the third memory area M3 regardless of whether the execution of the first segment S_{k,1} and the second segment S_{k,2} is completed. At this time, when the loading of the third segment S_{k,3} by the DMA controller is performed simultaneously with the execution of the first segment S_{k,1} by the processor, access to the first memory area by the processor and access to the third memory area by the DMA controller may be performed simultaneously for at least a portion of time (e.g., time from t₂ to t₃). Under this configuration, each of the first memory area M1, the second memory area M2, and the third memory area M3 may be separately allocated within the memory device. That is, the first memory area M1, the second memory area M2, and the third memory area M3 may not overlap within the memory device.

Thereafter, in response to the completion of the loading of the second segment S_{k,2} by the DMA controller and the completion of the execution of the first segment S_{k,1} by the processor, the processor may start the execution of the second segment S_{k,2}. In addition, in response to the completion of the loading of the third segment S_{k,3} by the DMA controller and the completion of the execution of the second segment S_{k,2} by the processor, the processor may start the execution of the third segment S_{k,3}.

With such a configuration, the DMA controller and the processor perform loading and execution in parallel for segments included in different segment groups, thereby reducing the time required to perform the task. For example, according to the example of FIG. 7, access to different memory areas is performed simultaneously by the processor and the DMA controller for at least a portion of time (e.g., time from t₁ to t₂, time from t₂ to t₃), thereby reducing the time required to perform the task by that amount of time (e.g., time from t₁ to t₂, time from t₂ to t₃) compared to the example of FIG. 5.

FIGS. 8 and 9 are diagrams for describing an example in which a memory area is allocated in a memory device according to some embodiments of the present disclosure.

Referring to FIGS. 8 and 9, the task may include a plurality of segments S_{k,1}, S_{k,2}, and S_{k,3}, and each of the plurality of segments S_{k,1}, S_{k,2}, and S_{k,3} may be allocated to any one of the plurality of segment groups. For convenience of description, it is assumed that the first segment S_{k,1} and the third segment S_{k,3} among the plurality of segments S_{k,1}, S_{k,2}, and S_{k,3} are allocated to the first segment group, and the second segment S_{k,2} is allocated to the second segment group.

Referring to FIG. 8, segments allocated to any one segment group among the plurality of segments S_{k,1}, S_{k,2}, and S_{k,3} included in the task may be stored in the same memory area within the memory device 230, and segments allocated to different segment groups may be stored in different memory areas within the memory device 230.

For example, the first segment S_{k,1} included in the first segment group may be stored in at least a portion of the first memory area M1 of the memory device 230. For example, the first memory area M1 may refer to a fixedly allocated area such that segments (e.g., the first segment S_{k,1}, the third segment S_{k,3}) included in the first segment group can be stored. In this case, the capacity of the first memory area M1 may be determined to be greater than or equal to the capacity (or size) of each of the segments included in the first segment group.

Thereafter, the second segment S_{k,2} included in the second segment group may be stored in the second memory area M2 separately allocated from the first memory area M1 within the memory device 230.

In an embodiment, the DMA controller (e.g., DMA controller 220 in FIG. 1) and the processor (e.g., processor 240 in FIG. 1) may simultaneously access the first memory area M1 and the second memory area M2. For example, during the time the DMA controller accesses the second memory area M2 of the memory device 230 for loading the second segment S_{k,2}, the processor may access the first memory area M1 of the memory device 230 for executing the first segment S_{k,1}. In addition, during the time the DMA controller accesses the first memory area M1 of the memory device 230 for loading the third segment S_{k,3}, the processor may access the second memory area M2 of the memory device 230 for executing the second segment S_{k,2}. For this purpose, the sum of the capacities of the first memory area M1 and the second memory area M2 may be determined to be less than or equal to the total capacity of the memory device 230.

Referring to FIG. 9, segments allocated to different segment groups among the plurality of segments S_{k,1}, S_{k,2}, and S_{k,3} included in the task may be stored in different memory areas within the memory device 230.

In an embodiment, the size of the memory area in which each of the plurality of segments S_{k,1}, S_{k,2}, and S_{k,3} is stored may be dynamically allocated according to the size of each of the plurality of segments S_{k,1}, S_{k,2}, and S_{k,3}.

For example, the first segment S_{k,1} included in the first segment group may be stored in the first memory area M1 of the memory device 230. Here, the capacity of the first memory area M1 may be determined to be greater than or equal to the capacity (or size) of the first segment S_{k,1}. During the time the first segment S_{k,1} is executed by the processor, the first segment S_{k,1} and/or data associated with the first segment S_{k,1} may be maintained in the first memory area M1.

Thereafter, the second segment S_{k,2} included in the second segment group may be stored in the second memory area M2 separately allocated from the first memory area M1 within the memory device 230. Here, the capacity of the second memory area M2 may be determined to be greater than or equal to the capacity (or size) of the second segment S_{k,2}.

Thereafter, when the execution of the first segment S_{k,1} by the processor is completed, the DMA controller may start loading the third segment S_{k,3} subsequent to the first segment S_{k,1}. At this time, the third segment S_{k,3} may be stored in the third memory area M3 of the memory device 230. Here, the capacity of the third memory area M3 may be determined to be greater than or equal to the capacity (or size) of the third segment S_{k,3}. In addition, the third memory area M3 may be an area separately allocated from the second memory area M2.

In an embodiment, the third memory area M3 may refer to an area different from the first memory area M1. For example, if the capacity (or size) of the first segment S_{k,1} and the capacity (or size) of the third segment S_{k,3} are different, the first memory area M1 and the third memory area M3 allocated based on the capacity of each segment may also be different. For example, at least a portion of the third memory area M3 may overlap at least a portion of the first memory area M1. As another example, the third memory area M3 may not overlap the first memory area M1. That is, the third memory area M3 may be determined as an arbitrary area among the areas separately allocated from the second memory area M2.

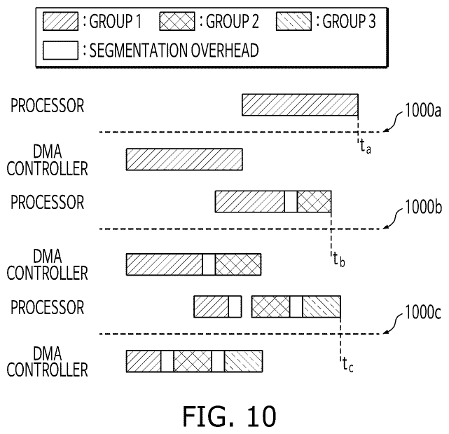

FIG. 10 is a diagram for describing an example in which each of a plurality of segments included in a task according to an embodiment of the present disclosure is allocated to any one of a plurality of segment groups. The scheduler (e.g., scheduler 242 in FIG. 1) may determine information on a plurality of segments for dividing the task (hereinafter, referred to as ‘first information’) and information for allocating the plurality of segments to one of the plurality of segment groups (hereinafter, referred to as ‘second information’) to optimize the execution process of the task transmitted from the external device (e.g., external device 100 in FIG. 1).

In an embodiment, the first information and the second information for the task may be determined such that the execution completion time of the task is within the predetermined deadline of the task. In addition, the first information and the second information for the task may be determined such that the execution completion time of the task is within the predetermined deadline of the task, and the task execution time is minimized, but are not limited thereto.

In an embodiment, in the process of determining the first information and the second information for the task, overhead generated when each of the plurality of segments is allocated to any one of the plurality of segment groups may be considered. Here, the overhead may include any delay time that may occur in the process in which the DMA controller and/or the processor process the task based on the first information and the second information. For example, the overhead may include a delay time occurring in the process in which the DMA controller changes the segment group for loading a segment, a delay time occurring in the process in which the processor changes the segment group for executing a segment, and a delay time occurring due to the intervention of the scheduler in the process of changing the segment group for loading and/or executing a segment.

The first example 1000a is an example when a segment included in a task is allocated to one segment group. In this case, it can be confirmed that parallel processing between segments is not possible, which may lengthen the total execution time of the task, but overhead due to segment group division does not occur.

The second example 1000b and the third example 1000c are examples when a segment included in a task is allocated to a plurality of different segment groups. In this case, parallel processing of segments allocated to each of the plurality of different segment groups is possible, but additional overhead due to segment group division may occur. In this case, the total execution time of the task may rather increase due to the overhead generated when each of the plurality of segments is allocated to any one of the plurality of segment groups. For example, as illustrated in FIG. 10, in the third example 1000c, the total time required to process the allocated segments by allocating the plurality of segments to three groups may be longer than the total time required to process the allocated segments by allocating the plurality of segments to two groups in the second example 1000b.

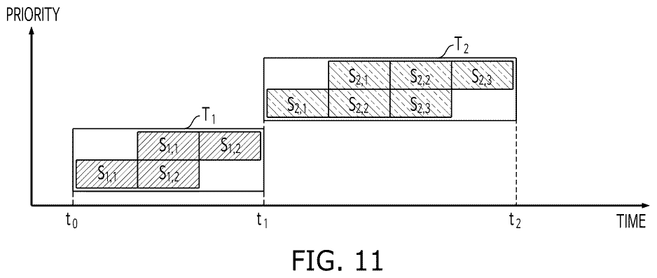

FIG. 11 is a diagram for describing an example in which a plurality of tasks according to an embodiment of the present disclosure are performed. In an embodiment, the computing device (e.g., computing device 200 in FIG. 1) may perform a plurality of tasks associated with each of a plurality of deep neural network models. For example, when the computing device executes a plurality of deep neural network models, a plurality of tasks T₁ and T₂ corresponding to each of the plurality of deep neural network models may be independently performed.

In an embodiment, the computing device may sequentially perform each of the plurality of tasks regardless of the priority of each of the plurality of tasks. For example, the computing device may perform the second task T₂ in response to the completion of the first task T₁.

As a specific example, the DMA controller (e.g., DMA controller 220 in FIG. 1) may start loading the first segment S2,1 of the second task T₂ subsequent to the first task T₁ in response to the completion of the execution of the last segment S_{1,2} of the first task T₁ by the processor (e.g., processor 240 in FIG. 1). That is, if the execution of the second task T₂ is requested after the execution of the first task T₁ has started, the computing device may start the second task T₂ after the first task T₁ is completed, regardless of the priority of the first task T₁ and the second task T₂.

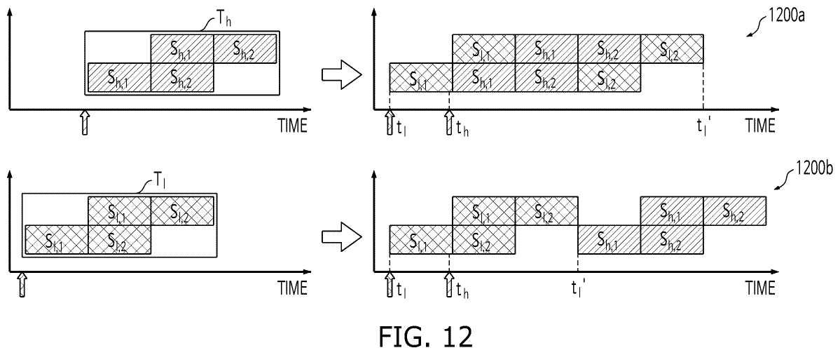

With such a configuration, the computing device may limit the resources of the DMA controller and the processor from being preempted by another task until the loading and execution of all segments included in one task are completed. Accordingly, when the computing device performs a plurality of tasks, interference between the plurality of tasks is minimized, and the worst-case execution time (WCET) of each task may be predicted more accurately. A specific example thereof will be described in more detail later with reference to FIGS. 12 to 14.

FIG. 12 is a diagram for comparing and describing a process of performing a plurality of tasks by a computing device according to an embodiment of the present disclosure and a process of performing a plurality of tasks by a computing device according to an example.

The first example 1200a is a diagram for describing a process in which a computing device according to an example performs a plurality of tasks, and the second example 1200b is a diagram for describing a process in which a computing device according to an embodiment of the present disclosure performs a plurality of tasks. In FIG. 12, descriptions of configurations explained in or overlapping with FIG. 11 are omitted.

In an embodiment, the computing device (e.g., computing device 200 in FIG. 1) may perform a plurality of tasks Tₕ and Tₗ associated with each of a plurality of deep neural network models. For convenience of description, it is assumed that the first task Tₗ has a lower priority than the second task Tₕ. In addition, it is assumed that the request time (tₗ) for performing the first task Tₗ for the computing device is before the request time (tₕ) for performing the second task Tₕ.

Referring to the first example 1200a, the computing device may start performing the first task Tₗ in response to the request for performing the first task Tₗ. For example, the DMA controller may start loading the first segment S_{l,1}, which is the first segment included in the first task Tₗ. At this time, if the performance of the second task Tₗ, which has a higher priority than the first task Tₗ, is requested while the first segment S_{l,1} is being loaded, the computing device may defer the execution of the first segment S_{l,1} and start the execution of the second task Tₗ in response to the completion of the loading of the first segment S_{l,1}. The execution of the first task Tₗ may be suspended (or deferred) until the execution of the second task Tₗ is completed. In this case, there is a problem that it is difficult to predict the completion time (tl′) of the execution of the first task Tₗ, making it difficult to guarantee the real-time performance of the first task Tₗ.

According to the second example 1200b, even if the execution of the second task Tₗ, which has a higher priority than the first task Tₗ, is requested while the first task Tₗ is being executed, the computing device may defer the execution of the second task Tₗ until the execution of the first task Tₗ is completed. That is, the computing device may start the execution of the second task Tₗ in response to the completion of the execution of the first task Tₗ. In this case, since the completion time (tₗ') of the execution of the first task Tₗ can be predicted along with the start of the execution of the first task Tₗ, it may be advantageous for guaranteeing the real-time performance of the first task Tₗ.

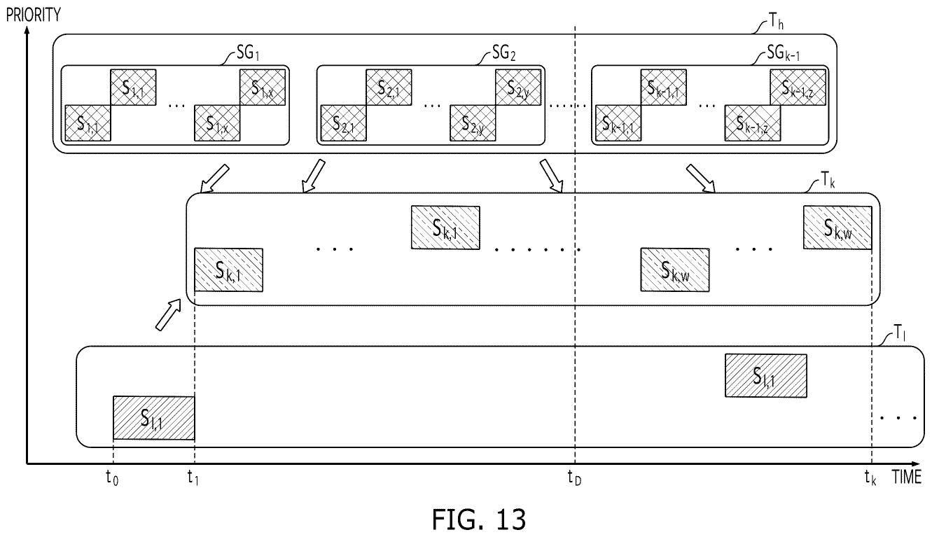

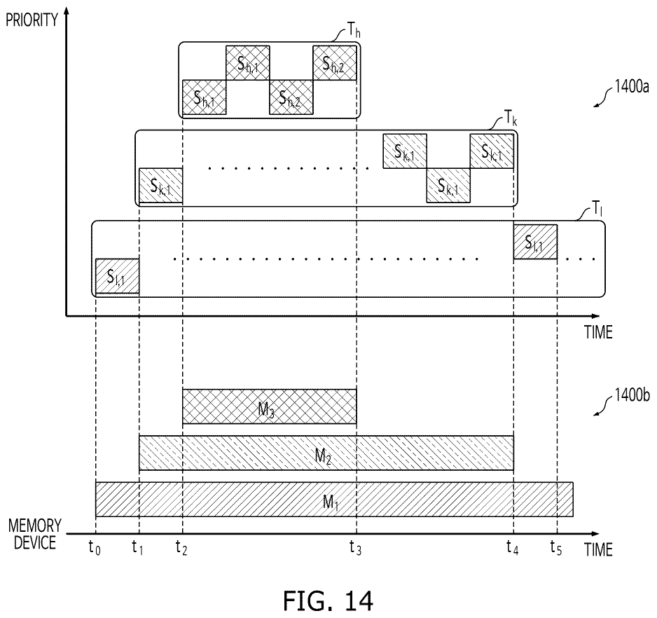

FIGS. 13 and 14 are diagrams for describing an example in which a plurality of tasks are executed in a computing device according to an example. FIG. 13 is a diagram for more specifically describing a process in which a computing device according to an example executes a plurality of tasks. In FIG. 13, descriptions of configurations explained in or overlapping with FIG. 12 are omitted.

In an embodiment, the computing device (e.g., computing device 200 in FIG. 1) may perform a plurality of tasks Tₕ, Tₖ, and Tₗ associated with each of a plurality of deep neural network models. For convenience of description, it is assumed that the second task Tₖ has a lower priority than the third task Tₕ, and a higher priority than the first task Tₗ.

Referring to FIG. 13, when the order in which the plurality of tasks Tₕ, Tₖ, and Tₗ are performed is adjusted according to the priority of each of the plurality of tasks Tₕ, Tₖ, and Tₗ, it may be difficult to predict the completion time of the plurality of tasks Tₕ, Tₖ, and Tₗ. For example, the time required to perform the second task Tₖ may be expressed by Equation 1 below.

lₖ=Cₖ+Bₘₐₓ+ΣIᵢ [Equation 1]

In Equation 1, the lₖ may indicate the predicted time required for the second task Tₖ. The Cₖ may indicate the pure time required (computation time) for the second task Tₖ, that is, the predicted pure time required when there is no interference from other tasks. The Bmax may indicate the delay time (blocking time) (e.g., time from t₀ to t₁) due to a task (e.g., the first task Tₗ) whose execution has started before the execution of the second task Tₖ is requested. The Iᵢ may indicate the interference time delayed due to interference from a task (e.g., the third task Tₕ) with a higher priority than the second task Tₖ.

According to Equation 1, if interference from tasks with higher priority than the second task Tₖ is allowed when or while the second task Tₖ is being performed, it becomes difficult to predict the completion time (tₖ) of the second task Tₖ, and accordingly, it may be difficult to guarantee that the completion time (tₖ) of the second task Tₖ is within the deadline (t_{D}) of the second task Tₖ.

Referring to FIG. 14, when the order in which the plurality of tasks Tₕ, Tₖ, and Tₗ are performed is adjusted according to the priority of each of the plurality of tasks Tₕ, Tₖ, and Tₗ, there is a problem that unnecessarily large memory resources are consumed to perform each task. In FIG. 14, for convenience of description, it is assumed that each of the first task Tₗ, the second task Tₖ, and the third task Tₕ is stored in a different single memory area of the memory device. For example, segments included in the first task Tₗ may be stored in the first memory area M1 of the memory device, segments included in the second task Tₖ may be stored in the second memory area M2 of the memory device, and segments included in the third task Tₕ may be stored in the third memory area M3 of the memory device.

Referring to the first example 1400a, if the execution of tasks with higher priority (e.g., the second task Tₖ, the third task Tₕ) is requested after the execution of the first task Tₗ, which has the lowest priority among the plurality of tasks Tₕ, Tₖ, and Tₗ, has started, the execution of the first task Tₗ may be suspended (or deferred). As a specific example, if the execution of the second task Tₖ is requested while the segment Sl,1 of the first task Tₗ is being loaded by the DMA controller, the DMA controller may start loading the first segment (e.g., segment S_{k,1}) of the second task Tₖ in response to the completion of the loading of the segment S_{l,1} of the first task Tₗ.

In this case, as illustrated in the second example 1400b, the memory device may maintain data associated with the segment S_{l,1} in the first memory area M1 until the execution of the segment S_{l,1} is completed. Alternatively, the computing device may perform an operation of writing data associated with the segment S_{l,1} to an arbitrary storage space provided separately from the first memory area M1 until the execution of the segment S_{l,1} starts.

In this case, unnecessary memory resources may be wasted to store data associated with the segment S_{l,1}. In addition, if the above-described process is repeated for the plurality of tasks Tₕ, Tₖ, and Tₗ, the unnecessary memory allocation of the memory device may increase, and the task performance of the computing device may be degraded.

What is claimed is:

1. A computing device comprising:
a memory device;
a direct memory access (DMA) controller that is configured to load a first task into the memory device on a segment-by-segment basis, the first task being associated with a deep neural network (DNN) model and comprising a plurality of segments, and wherein the plurality of segments comprise a first segment and a second segment; and
a processor configured to execute at least one segment loaded in the memory device on a segment-by-segment basis,
wherein each of the plurality of segments is comprised in one of a plurality of segment groups, the plurality of segment groups comprising a first segment group and a second segment group,
wherein the memory device comprises a first memory area and a second memory area, and the first memory area and the second memory area are separately allocated in the memory device,
wherein the DMA controller is further configured to, during a time that data associated with the first segment comprised in the first segment group is maintained in the first memory area, load data associated with the second segment included in the second segment group into the second memory area, and
wherein the processor is further configured to access the first memory area during a same time the DMA controller accesses the second memory area.

2. The computing device as claimed in claim 1, wherein the first segment group comprises the first segment and a third segment subsequent to the first segment,
wherein the processor is further configured to start execution of the first segment based on loading of the first segment being completed, and
wherein the DMA controller is further configured to start loading the third segment based on execution of the first segment being completed.

3. The computing device as claimed in claim 2, wherein the memory device is further configured to:
maintain data associated with the first segment stored in the first memory area during a time the processor executes the first segment, and
store data associated with the third segment in the first memory area based on execution of the first segment being completed.

4. The computing device as claimed in claim 2, wherein the memory device is further configured to:
maintain data associated with the first segment stored in the first memory area during a time the processor executes the first segment, and
store data associated with the third segment in a third memory area based on execution of the first segment being completed, wherein the third memory area is separately allocated from the second memory area.

5. The computing device as claimed in claim 4, wherein at least a portion of the third memory area overlaps at least a portion of the first memory area.

6. The computing device as claimed in claim 4, wherein:
a size of the first memory area is dynamically allocated based on a size of the first segment,
a size of the second memory area is dynamically allocated based on a size of the second segment, and
a size of the third memory area is dynamically allocated based on a size of the third segment.

7. The computing device as claimed in claim 1, wherein the DMA controller is further configured to load the second segment included in the second segment group into the second memory area during a time the processor executes the first segment included in the first segment group.

8. The computing device as claimed in claim 7, wherein the processor is further configured to start execution of the second segment based on execution of the first segment being completed and loading of the second segment being completed.

9. The computing device as claimed in claim 1, wherein the DMA controller is further configured to load a second task based on execution of the first task being completed, the second task being subsequent to the first task.

10. The computing device as claimed in claim 1, wherein each of the plurality of segments comprises information on at least one layer of a plurality of layers of the DNN model.

11. The computing device as claimed in claim 1, wherein each of the plurality of segments is allocated to one of the plurality of segment groups based on a deadline of the first task and a capacity of the memory device.

12. The computing device as claimed in claim 11, wherein each of the plurality of segments is allocated to the one of the plurality of segment groups based on a task completion time of the first task being within a predetermined deadline of the first task.

13. The computing device as claimed in claim 11, wherein each of the plurality of segments is allocated to the one of the plurality of segment groups based on a sum of capacities of memory areas simultaneously accessed by the DMA controller and the processor at a time during execution of the first task in the memory device being less than or equal to a total capacity of the memory device.

14. The computing device as claimed in claim 1, wherein each of the plurality of segments is allocated to the one of the plurality of segment groups before the first task is executed, and
the DMA controller is further configured to load the first task into the memory device based on scheduling information indicating, for each of the plurality of segments, which one of the plurality of segment groups a respective segment is assigned to.

15. The computing device as claimed in claim 1, wherein the DMA controller is further configured to load the plurality of segments on a segment-by-segment basis from an external device that stores the first task, and
a capacity of the memory device is less than a capacity of the first task.

16. A computing system comprising:
an external device storing tasks associated with a deep neural network (DNN) model; and
a computing device electrically connected to the external device to execute the tasks,
wherein the computing device comprises:
a memory device;
a DMA controller configured to load a first task received from the external device into the memory device on a segment-by-segment basis, the first task being associated with the DNN model and comprising a plurality of segments, and wherein the plurality of segments comprise a first segment and a second segment; and
a processor configured to execute at least one segment loaded in the memory device on a segment-by-segment basis,
wherein each of the plurality of segments is comprised in one of a plurality of segment groups, the plurality of segment groups comprising a first segment group and a second segment group,
wherein the memory device comprises a first memory area and a second memory area, and the first memory area and the second memory area are separately allocated in the memory device,
wherein the DMA controller is further configured to, during a time that data associated with the first segment comprised in the first segment group is maintained in the first memory area, load data associated with the second segment included in the second segment group into the second memory area, and
wherein the processor is further configured to access the first memory area during a same time the DMA controller accesses the second memory area.

17. The computing system as claimed in claim 16, further comprising a scheduler configured to allocate each of the plurality of segments to one of the plurality of segment groups before the first task is executed, and
wherein the DMA controller is further configured to load the first task into the memory device based on scheduling information indicating, for each of the plurality of segments, which one of the plurality of segment groups a respective segment is assigned to.

18. The computing system as claimed in claim 16, wherein the first segment group comprises the first segment and a third segment subsequent to the first segment,
wherein the processor is further configured to start execution of the first segment based on loading of the first segment into the first memory area being completed, and
wherein the DMA controller is further configured to start loading the third segment into a third memory area based on execution of the first segment being completed, wherein the third memory area is separately allocated from the second memory area.

19. The computing system as claimed in claim 16, wherein the DMA controller is further configured to load the second segment included in the second segment group into the second memory area during a time the processor executes the first segment included in the first segment group.

20. A computing device comprising:
a memory device;
a direct memory access (DMA) controller configured to load a first task into the memory device on a segment-by-segment basis, the first task being associated with a deep neural network (DNN) model and comprising a plurality of segments, and wherein the first task and a second task are associated with a deep neural network model; and
a processor configured to execute at least one segment loaded in the memory device on a segment-by-segment basis,
wherein the DMA controller is further configured to load the second task subsequent to the first task based on execution of the first task being completed,
wherein each of the plurality of segments comprised in the first task is comprised in one of a plurality of segment groups, the plurality of segment groups comprising a first segment group and a second segment group,
wherein the memory device comprises a first memory area and a second memory area, and the first memory area and the second memory area are separately allocated in the memory device,
wherein the DMA controller is further configured to, during a time that data associated with the first segment comprised in the first segment group is maintained in the first memory area, load data associated with the second segment included in the second segment group into the second memory area, and
wherein the processor is further configured to access the first memory area during a same time the DMA controller accesses the second memory area.
